(19) United States
(12) Patent Application Publication
(10) Pub. No.: US 2008/0251674 A1
(43) Pub. Date: Oct. 16, 2008

(54) Holding apparatus

(75) Inventor: Yung-Chun Su, Sinjhuang City (TW)

Correspondence Address: Muncy, Geissler, Olds & Lowe, PLLC, P.O. BOX 1364, FAIRFAX, VA, 22038-1364, US

(73) Assignee: Qisda Corporation, Taoyuan County (TW)

(21) Appl. No.: 12/081,165

(22) Filed: Apr. 11, 2008

(30) Foreign Application Priority Data
Apr. 13, 2007 (TW) 096113088

(51) Int. Cl. F16M 11/00

(52) U.S. Cl. 248/346.04

(57) ABSTRACT

A holding apparatus comprises a holding component and a base. One end of the holding component is connected to an electronic device. A first restricting part is disposed on the other end of the holding component. The base includes a base body and a connecting device. The connecting device is disposed on the base body for connecting with the holding component. The connecting device includes a first face and a second face extending downward, respectively. The first face is flexible and movable toward the second face and has a first restricting component. The first restricting component is disposed corresponding to the first restricting part and is engagable with the first restricting part.

### BACKGROUND OF THE INVENTION

1. Field of the Invention

The present invention relates generally to a holding apparatus. Particularly, the present invention relates to a holding apparatus for supporting a display.

2. Description of the Prior Art

Displays have been used to be one of the most accessible information products. Besides, the displays can be the essential output equipments of electronic devices such as personal computers, televisions, game machines.

Human eyes are the receptor of the image from the display. In order to have better visual effect and to dispose on the disk or table, such displays usually have a holding apparatus for supporting the monitors thereof and have an appropriate visual angle for users. The typical holding apparatus has a bottom and a holding component on a bottom thereof. One end of the holding component is connected to the displays or monitors, while the other end is connected to the bottom.

For saving space and increasing convenience of conveyance, the holding apparatus always disassembles as a bottom and a holding component until users or consumers put them together. Currently, the assemblage of the holding component and the bottom can be performed by engagement between a protuberant and a hole. However, when users want to disassemble such display, this chore requires more than two persons or using specific tool to disengage those protuberant and holes for disassembly of the displays. Thus, the convenience of disassembling such displays still requires improvement.

### SUMMARY OF THE INVENTION

It is an object of the present invention to provide a holding apparatus for facile assembly of the displays.

The present invention includes a base and a holding component. One end of the holding component is connected to an electronic device while the other end of the holding component has a first restricting part. In the preferable embodiment, the electronic device includes a display or a monitor. The base includes a base body and a connecting device. The connecting device is disposed on the base body for connecting to the holding component. The connecting device has a first face and a second face extending downward respectively, wherein the first face is flexible and movable toward the second face and has a first restricting component and has a first restricting component. The first restricting component is disposed corresponding to the first restricting part and is engagable with the first restricting part.

Furthermore, the second face is static corresponding to the base body. The holding component further has a second restricting part disposed corresponding to the first restricting part. The second face further has a second restricting component, wherein the second restricting component is disposed corresponding to the second restricting part and is engagable with the second restricting part.

In addition, the connecting device further has a third face and a fourth face being connected to the base body to dispose the connecting device on the base body. The first restricting part includes a hole. The first restricting component includes a protuberant. The second restricting part includes a hole. The second restricting component includes a protuberant for engaging with the second restricting part.

### BRIEF DESCRIPTION OF THE DRAWINGS

FIG. 1 is a schematic diagram of the present invention.

FIG. 2 is a perspective view of the preferable embodiment of the present invention.

FIG. 3 is a schematic diagram of the single restricting part and restricting component.

FIG. 4 is a lateral schematic diagram of non-engaging embodiment of the present invention.

FIG. 5 is a lateral schematic diagram of engaging embodiment of the present invention.

FIG. 6 is a lateral schematic diagram of disengaging embodiment of the present invention

FIG. 7 is a lateral schematic diagram of the non-penetrating groove embodiment of the present invention.

FIG. 8 is another schematic diagram of the present invention.

FIG. 9 is a schematic diagram of connecting between the second face and the base body.

FIG. 10 is another schematic diagram of connecting between the second face and the base body.

FIG. 11 is the other schematic diagram of connecting between the second face and the base body.

### DETAILED DESCRIPTION OF THE PREFERRED EMBODIMENT

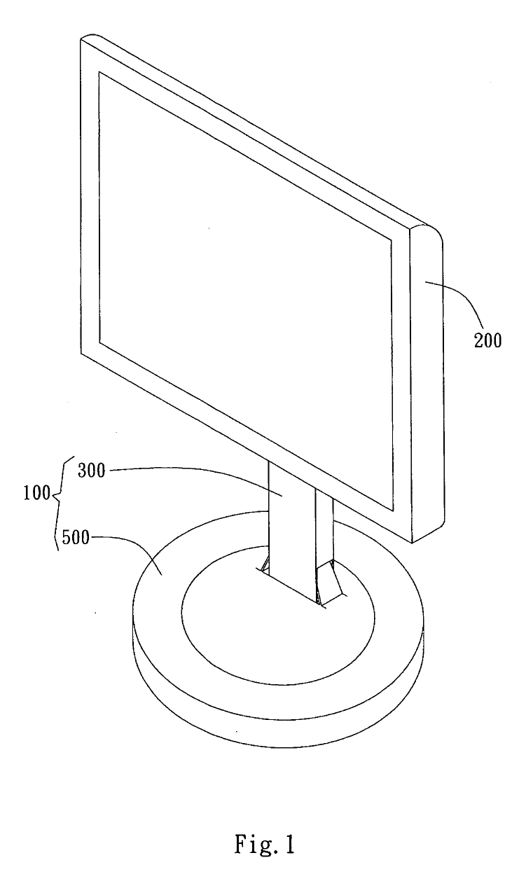

The present invention provides a holding apparatus for supporting a subject. In the preferable embodiment shown in FIG. 1, the subject 200 is a computer monitor. The holding apparatus 100 is a computer holding component. However, in other embodiments, the holding apparatus 100 can be used for a TV monitor, a lamp, or other subjects.

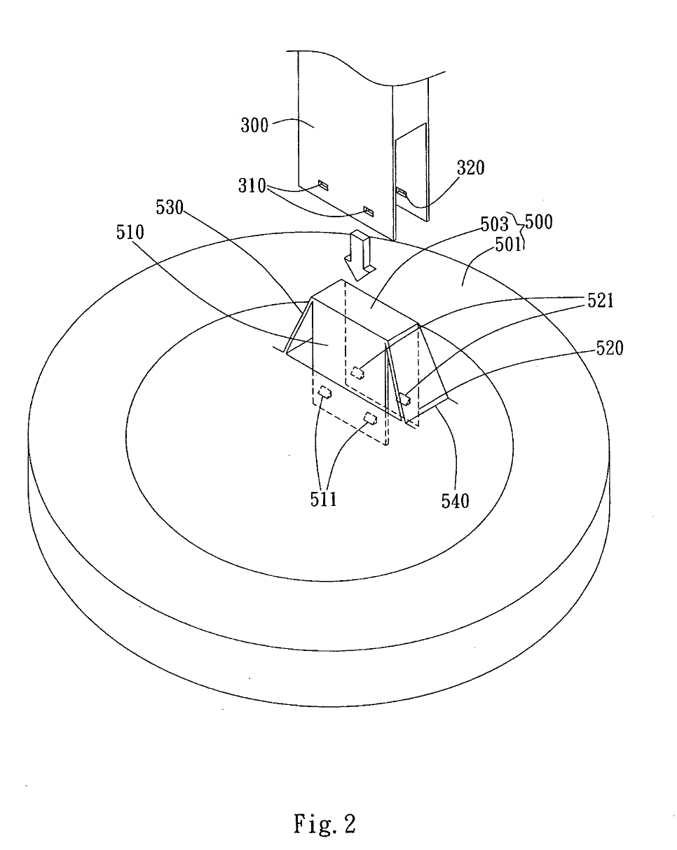

In the preferable embodiment shown in FIG. 2, the holding apparatus 100 includes a holding component 300 and a base 500. One end of the holding component 300 is connected to the subject 200 while the other end of the holding component 300 has a first restricting part 310 and a second restricting part 320. Wherein, the second restricting part 320 is disposed opposite to the first restricting part 310. The base 500 includes a base body 501 and a connecting device 503. The connecting device 503 is disposed on the base body 501 for connecting to the holding component 300.

The connecting device 503 includes a first face 510 and a second face 520 extending downward, wherein the first face 510 and the second face 520 are flexible and movable toward each other. The first face 510 has a first restricting component 511, wherein the first restricting component 511 corresponding to the first restricting part 310 can engage with the first restricting part 310. The second face 520 has a second restricting component 521, wherein the second restricting component 521 corresponding to the second restricting part 320 can engage with the second restricting part 320. The connecting device 503 is disposed on the base body 501 through a connection among a third face 530, a fourth face 540 and base body 501. The third face 530 and fourth 540 is preferably disposed lateral between the first face 510 and the second face 520.

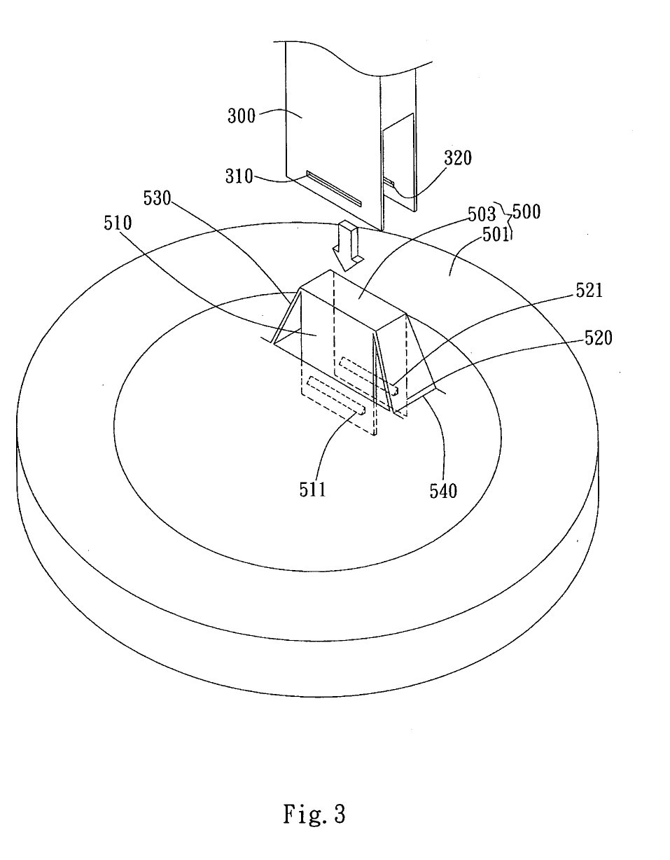

In the preferable embodiment shown in FIG. 2, the first restricting component 511 and the second restricting component 521 are plural protuberant. The first restricting part 310 and the second restricting part 320 are plural holes for engagement with such protuberant. However, in the other embodiments shown in FIG. 3, the first restricting component 511 and the second restricting component 521 can be a single protuberant, wherein the first restricting part 310 and the second restricting 320 can be a single hole for engagement with such protuberant.

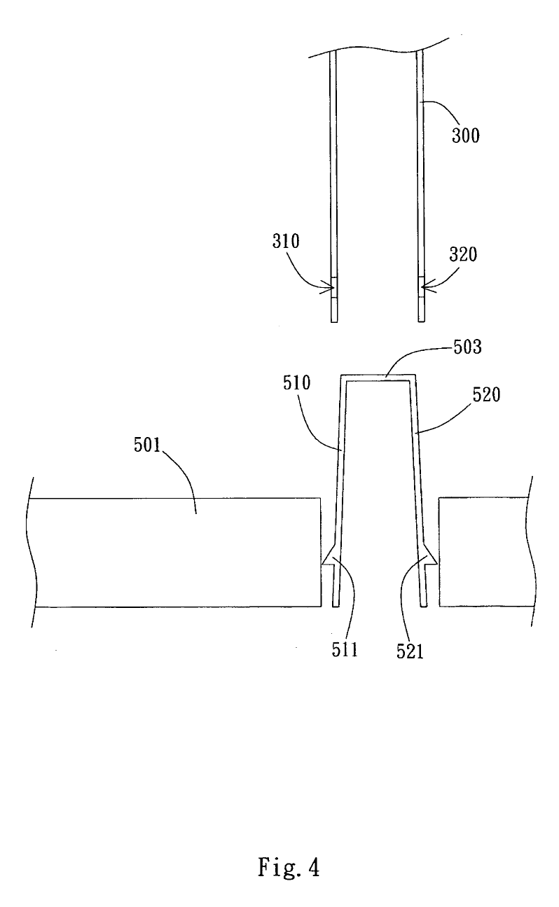

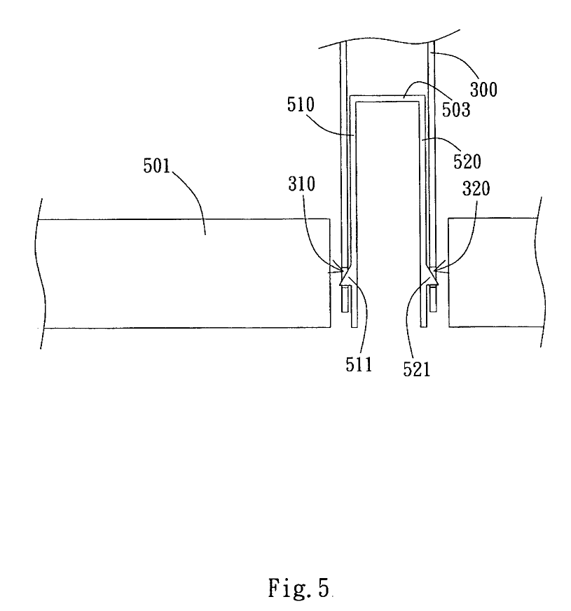

In the preferable embodiment shown in FIG. 4, when the holding component 300 dose not connect to the connecting device 503, the horizontal distance between the first restricting component 511 of the first face 510 and the second restricting component 521 of the second face 520 is larger than the horizontal distance the first restricting part 310 of the holding component 300 and the second restricting part 320 thereof. However, the top distance of the first restricting component 511 and the second restricting component 521 is smaller than the distance of the first restricting part 310 and the second restricting part 320 for guiding the connecting device 503 to insert into the holding component 300. Therefore, in the preferable embodiment shown in FIG. 5, when the holding component 300 is connected to the connecting device 503, the distance between the first face 510 and the second face 520 will be restrained by the holding component 300 to make the first face 510 and the second face 520 movable toward each other. Such movement will generate a recover force. By the recover force, it is allowable to make the first restricting component 511 and the second restricting component 521 engage with the first restricting part 310 and the second restricting part 320, respectively.

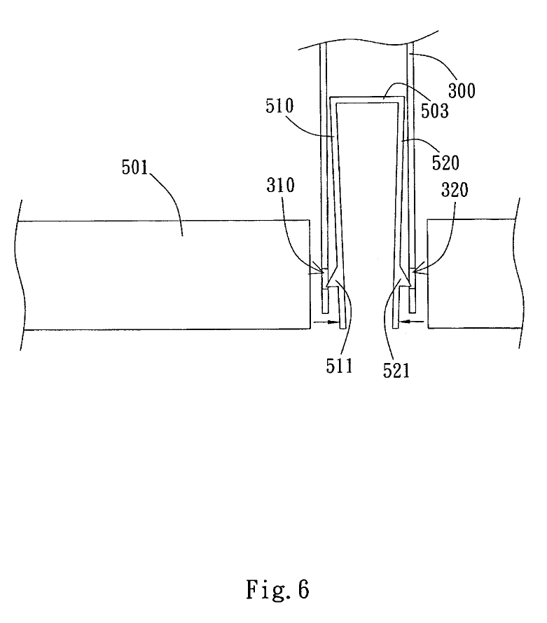

In the preferable embodiment shown in FIG. 6, when pressing the first face 510 and the second face 520 makes the first face 510 and the second face 520 move toward each other, it is allowable to make the distance between the first face 510 and second face 520 decrease to smaller than the horizontal distance of both side where the holding component 300 engages with the connecting device 503. The first restricting component 511 and the second restricting component 521 can disassemble away the first restricting part 310 and the second restricting part 320, respectively; such movement will make the holding component 300 disengage with the connecting device 503. On the other hand, when the users use two fingers of single hand to press the first face 510 and the second face 520, it is practicable to disengage the first restricting part 310 and the second restricting part 320 with the first restricting component 511 and the second restricting component 512, respectively. Such pressing force allows the disassembly between the holding component 300 and the connecting device 503.

In the preferable embodiment, the material of the connecting device 503 is high polymer plastics and can integrate with the base body 501. However, in other embodiments, the material of the connecting device 503 can be metal, alloy, or other flexible materials but not limited to integrate with the base body 501.

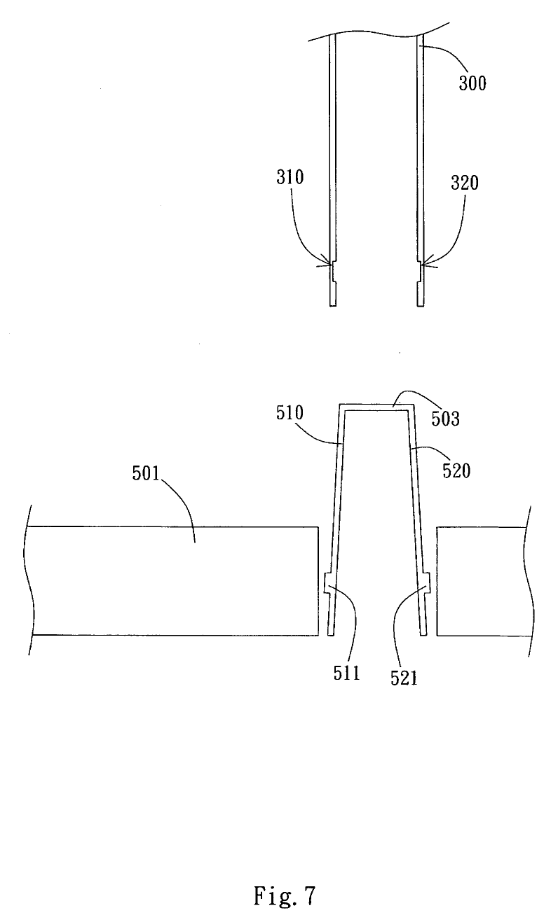

In the preferable embodiment shown in FIG. 4, the first restricting part 310 and the second restricting part 320 are penetrating holes for fixing. However, in other embodiments, the first restricting part 310 and the second restricting part 320 can be penetrating grooves or non-penetrating holes or grooves. In the embodiment shown in FIG. 7, the first restricting part 310 and the second restricting part 320 are non-penetrating grooves.

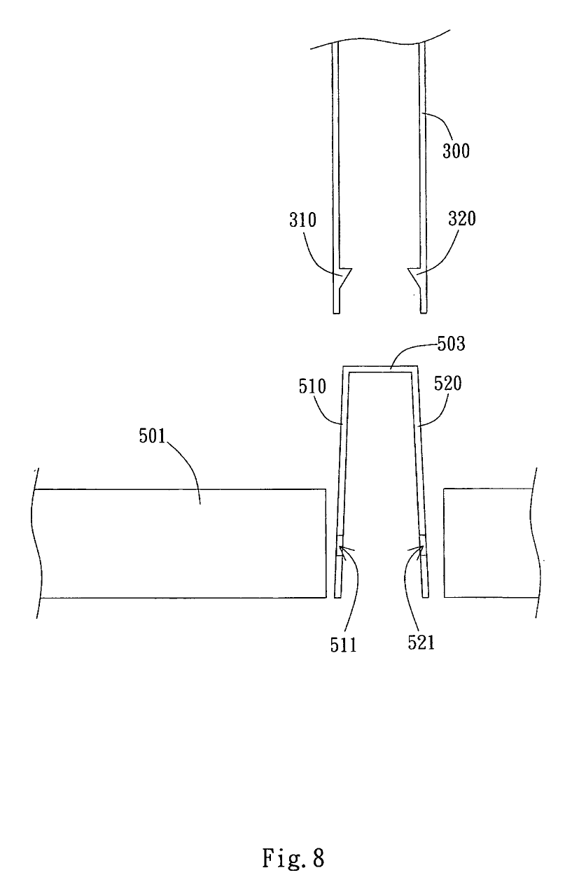

In the preferable embodiment shown in FIG. 4, the first restricting part 310 and the second restricting part 320 are holes, respectively; while the first restricting component 511 and the second restricting component 521 are the corresponding protuberant. However, in other embodiments shown in FIG. 8, the first restricting part 310 and the second restricting part 320 are protuberant, respectively; while the first restricting component 511 and the second restricting component 521 are corresponding holes.

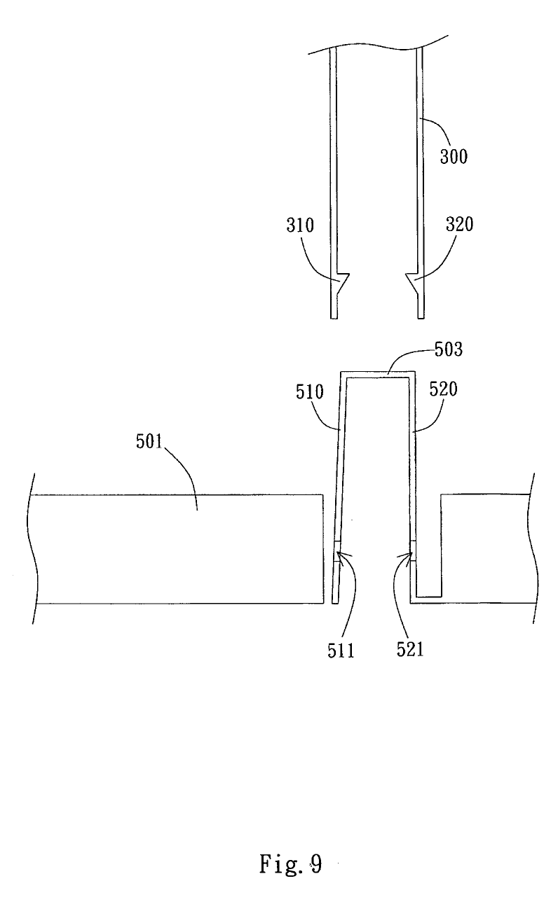

In the preferable embodiment shown in FIG. 4, the first face and the second face of the connecting device 503 are respectively extending downward and do not connect with the base body 501. However, in other embodiments, either the first face 510 or the second face 520 can connect with the base body 501. In the embodiment shown in FIG. 9, the second face 520 of the connecting device 503 can connect with the base body 501. The first face 510 is flexible and movable toward the second face 520. When the holding component 300 is not connected to the connecting device 503, the horizontal distance between the first restricting component 511 of the first face 510 and the second restricting component 521 of the second face 520 is larger than the horizontal distance between the first restricting part 310 of the holding component 300 and the second restricting part 320 thereof. However, the base distance between the first restricting part 310 and the second restricting part 320 is smaller than the horizontal distance between the first restricting component 511 and the second restricting component 521 to guide the holding component 300 to insert into the connecting device 503. Thus, when the holding component 300 connects to the connecting device 503, the horizontal distance between first face 510 and the second face 520 will be restrained by the holding component 300.

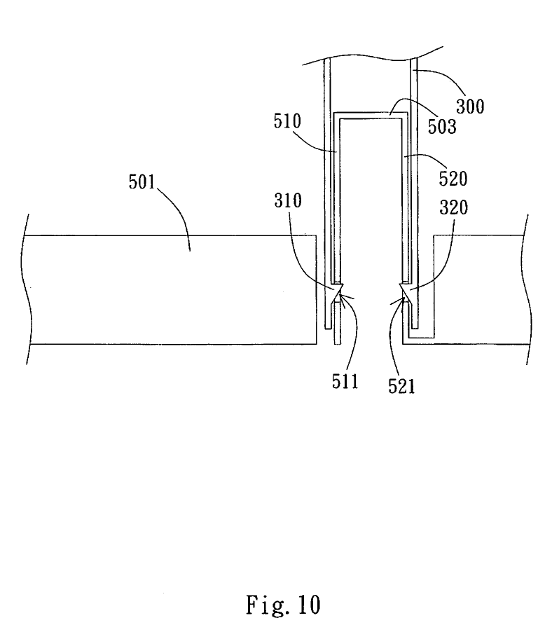

In the embodiment shown in FIG. 10, when the connecting component 300 connects to the connecting device 503, the horizontal distance between the first face 510 and the second face 520 will be restrained by holding component 300 to make the first face 510 movable toward the second face 520. This movement generates a recover force. By the recover force, it can make the first restricting component 511 and the second restricting component 521 engage with the first restricting part 310 and the second restricting part 320 to fixing.

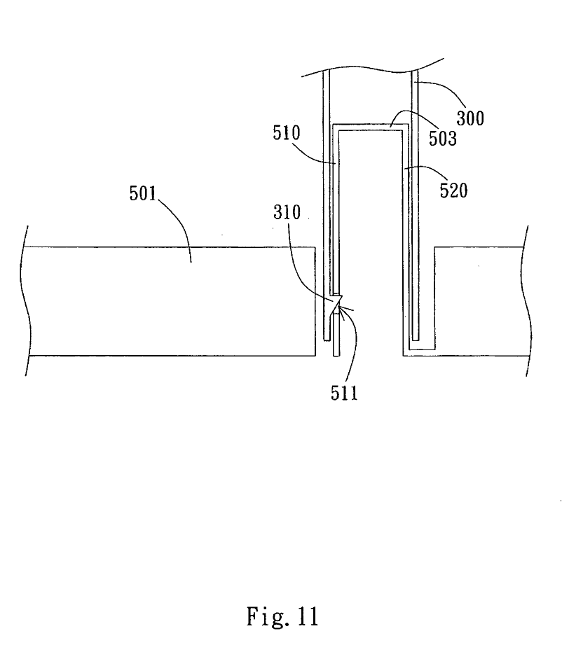

In the embodiment shown in FIG. 10, the first face 510 of the connecting device 503 and the second face 520 thereof have a first restricting component 511 and the second restricting component 521, respectively. The holding component 300 has a first restricting component 511 and a second restricting component 521 which are disposed corresponding to the first restricting part 310 and the second restricting part 320. However, in other embodiments, the restricting components can only be disposed on the first face 510. In the embodiment shown in FIG. 11, the connecting device 503 only has a first face 510 which has a first restricting component 511 while the holding component 300 has a first restricting part 310 corresponding to the first restricting component 511. When the holding component 300 connects with the connecting device 503, the first restricting component 511 engages with the first restricting part 310 for fixing. In this embodiment, users only need to press the first face 510 to disengage the first restricting part 310 and the first restricting component 511 to make the holding component 300 disassemble the connecting device 503.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A holding apparatus for supporting a subject comprising:
a holding component having a first restricting part disposed on one end of the holding component, wherein the other end of the holding component is connected to the subject; and
a base including:
a base body; and
a connecting device being disposed on the base body for connecting with the holding component, wherein the connecting device has a first face and a second face extending downward respectively, the first face is flexible and movable toward the second face and has a first restricting component, the first restricting component is disposed corresponding to the first restricting part and is engagable with the first restricting part.

2. The holding apparatus of claim 1, wherein the second face is static corresponding to the base body.

3. The holding apparatus of claim 1, wherein the holding component further has a second restricting part disposed corresponding to the first restricting part.

4. The holding apparatus of claim 3, wherein the second face further has a second restricting component, the second restricting component is disposed corresponding to the second restricting part and is engagable with the second restricting part.

5. The holding apparatus of claim 1, wherein connecting device further has a third face and a fourth face being connected to the base body to dispose the connecting device on the base body, the third face and the fourth face are disposed lateral between the first face and the second face.

6. The holding apparatus of claim 1, wherein the subject includes a display.

7. The holding apparatus of claim 1, wherein the first restricting part includes a hole.

8. The holding apparatus of claim 1, wherein the first restricting component includes a protuberant.

9. The holding apparatus of claim 3, wherein the second restricting part includes a hole.

10. The holding apparatus of claim 4, wherein the second restricting component includes a protuberant.
